(19) United States
(12) Patent Application Publication
(10) Pub. No.: US 2025/0351757 A1
(43) Pub. Date: Nov. 20, 2025

(54) AGRICULTURAL WORKING MACHINE

(71) Applicant: Grimme Landmaschinenfabrik GmbH & Co. KG, Damme (DE)

(72) Inventors: Ansgar Lange gen. Detert, Melle (DE); Kai Dernjac, Vechta (DE); Michael Dreishing, Neuenkirchen-Vörden (DE)

(21) Appl. No.: 19/204,850

(22) Filed: May 12, 2025

(30) Foreign Application Priority Data
May 14, 2024 (DE) 202024102481.8

(51) Int. Cl. A01B 33/02

(52) U.S. Cl. CPC A01B 33/024

(57) ABSTRACT

An agricultural working machine is provided in the form of a soil tillage machine designed as a soil tiller. A shaft is provided with at least one tool, the rotation axis of which extends in operation at an angle to the direction of travel and at least substantially parallel to the ground. A housing is arranged on a frame of the working machine at least in sections above the shaft, and has an inner wall delimiting a channel between the shaft and the housing. The housing has a front and a rear, movable housing part with respect to the direction of travel, with respective inner wall parts which each extend along the shaft and which each have at least two adjustable, different operating positions in which the respective inner wall parts of the housing parts are positioned differently to the shaft.

### CROSS REFERENCE

This application claims priority to German Patent Application No. 20 2024 102481.8, filed May 14, 2024, the entirety of which is hereby incorporated by reference.

### FIELD OF THE INVENTION

The present invention relates to an agricultural working machine.

### BACKGROUND OF THE INVENTION

In state-of-the-art agricultural working machines, particularly soil tillage machines, there are a number of options for controlling earth cultivation and in particular the preparation of the earth or soil, particularly in potato cultivation. On the one hand, attempts are being made to reduce earth adhesion in the rotor housing, for example, by using spring-mounted housings. On the other hand, different tools on a rotating shaft or a rotor shaft, for example, in the form of different tine geometries or by changing the speed, are used to control the crumbling size of the earth or soil to be processed. It has been found, however, that the spring suspension of the housing does not lead to a sufficient reduction in soil adhesion. On the other hand, replacing tools in the form of tines or even individual rotor shafts is time-consuming. In addition, speed changes on the gearbox are only available in very limited ratios.

EP 1 673 968 A1 discloses an inner wall made of an elastomeric material and provided with a freely oscillating end in order to reduce the adhesion of earth.

### BRIEF SUMMARY OF THE INVENTION

The object of the present invention is to improve earth cultivation and in particular earth preparation in a soil tillage machine.

An agricultural working machine according to the invention, in particular in the form of a soil tillage machine designed preferably as a soil tiller, is characterized in that the housing has a front and a rear movable housing part with respect to the direction of travel present during operation, with respective inner wall parts which each extend along the shaft and, which each have at least two adjustable, different operating positions, in which the respective inner wall parts of the housing parts are positioned differently with respect to the shaft or its rotation axis, in particular at different distances. The invention is based in particular on the finding that the soil conveyed through the channel and processed in the channel is specifically processed and therefore influenced by the different positioning of a housing, which is divided into at least two parts in the circumferential direction, relative to the shaft. By setting desired housing positions and using two housing parts, namely a front and a rear housing part, with respective inner wall parts, targeted adjustments, in particular position and/or shape changes, can be made to the housing and thus also the earth build-up can be specifically prevented. The housing therefore not only serves simply as an enclosure for the shaft, but with its different operating positions also as a control variable for processing the soil.

To set the respective operating position, the working machine has an actuating device via which the housing parts can be fixed in the various operating positions relative to the frame of the working machine or to a fixed housing frame.

The inner wall parts together and in particular completely form the inner wall of the housing. An inner wall in the sense of the invention is a wall that delimits the channel inwards, i.e., from the housing in the direction of the shaft or rotation axis. In single-skin housings, the inner wall is also an outer wall.

According to the invention, it is possible for the operation of the working machine to specifically influence the soil initially transferred into the channel differently during its path through the channel in the circumferential direction partially around the rotation axis, through the front and rear housing parts, wherein this is independent of the direction in which the shaft rotates. In operation, its rotation axis is angled to the direction of travel in such a way that the direction of travel and the rotation axis intersect in a plan view of the working machine. In particular, the rotation axis runs at a 90° angle to the direction of travel. In addition, the rotation axis runs at least substantially parallel to the ground in such a way that it is at an angle of +/−20° to the horizontal ground. In particular it runs parallel to the ground. In addition, the housing is arranged in sections above the shaft in such a way that, viewed in the direction of the rotation axis, the housing defines the channel at least at an angle of +/−30° to the perpendicular through the rotation axis or to the perpendicular to the ground. In particular this applies to an angle of +/−45° and, even more preferably, to at least one angle range of +/−65° to the perpendicular. In addition, the angular range covered by the housing can preferably be less than 180°.

The direction of travel of the working machine is set to straight-ahead driving. The channel is the area formed between the shaft and the housing, wherein tools of the shaft passing through the channel during operation are not taken into account.

For improved adjustment of the housing parts, these can swivel relative to the frame about at least one swivel axis, and in particular about a swivel axis that runs at an angle to the direction of travel and in particular parallel to the rotation axis of the shaft. For maintenance purposes in particular, the rear housing part can preferably swivel upwards by at least 60°, and more preferably by at least 90°.

Advantageously, the respective swivel bearings are formed at the ends of the housing parts facing each other, so that a front edge of the front housing part and a rear edge of the rear housing part can swivel upwards. Such swiveling allows a shaft with a larger diameter or longer tools to be used, especially if the shaft can also be lowered relative to the frame and housing using a shaft actuating device. In particular the at least one, then joint swivel bearing of the two housing parts is arranged exactly above the shaft.

The height of the inlet or outlet channel for the soil to be processed can be adjusted accordingly. On the other hand, this allows better accessibility for maintenance of the shaft from both the front and the rear.

In particular the respective swivel bearings are arranged exactly above the shaft, so that a symmetrical and in particular identical structure of the front and rear housing parts can result. If the front and rear housing parts also have the same design with regard to the inner wall parts, the front and rear housing parts can have an identical structure, which has advantages for production and maintenance.

Advantageously, the swivel axes are formed above the inner wall parts delimiting the channel, so that the swivel bearings are protected from the soil to be worked on. In particular the corresponding borders of the edges of the front and rear housing parts, which are directed towards each other, are close to each other in order to leave as small a gap as possible in the direction of the rotation axis.

At least one cross member and/or at least one side member is provided to stiffen at least one of the housing parts. Such carriers are also suitable for the arrangement of any functional parts, in particular for connection to a . . . .

According to a further development of the invention, the side members and/or the cross members can form one or more swivel bearings, via which the swivel axis of the respective housing part is defined. Preferably, viewed in the direction of travel across the width of the housing, a plurality of side members are provided, to which a plurality of cross members are attached, running in particular parallel to the rotation axis.

According to a further development of the invention, the inner wall parts of the housing parts are at least formed from an elastomeric material. Due to the elastic movement of the inner wall parts due to the elastomeric material, especially with Shore hardness A between 75 and 95, less earth adheres and the preparation of the soil can be more defined due to the reduced interference from adhering earth.

According to a further development of the invention, side members and cross members of a respective housing part are attached to one another to form a housing part frame, in particular wherein at least one of the side members is arranged to move relative to at least one of the cross members and/or at least one inner wall part is arranged to move relative to the housing part frame. For example, a cross member can be arranged in longitudinal holes in several side members. Due to the relative mobility, the housing part frame, by which the inner wall parts are supported, is deformable, for which suitable actuators can be used. The different frame shapes result in different shapes of the inner wall and thus adjustment options for the earth preparation.

A housing part thus comprises in particular an inner wall part, which may also be multi-part, and a housing part frame on which the inner wall part or parts are arranged. The housing part frame can be movably mounted in a fixed housing frame or the frame of the working machine.

Several side members in particular can be coupled together and positively guided in such a way that a different shape of the housing part results if the housing frame is moved from a first to a second operating position.

According to a further development of the invention, the elastic inner wall parts can also be suspended from at least one of the supports via elongated holes and be movable relative to these for the purpose of changing shape.

Preferably, at least one of the housing parts has different radii of curvature in at least two operating states. By transferring the housing parts from one operating state to the other, different scenarios for soil tillage are thus realized, as the characteristics of the channel extending around the shaft change. The radius of curvature corresponds to the radius that is formed in the direction of the rotation axis and from this towards the inner surface of the inner wall. The radius of curvature does not have to be a constant radius for the course of the inner wall around the rotation axis. Rather, it can be a varying radius, so that the distances of identical areas or points of the housing wall to the rotation axis are different in at least two operating states.

Preferably, the front edge swivels by at least 5°, in particular by at least 25° about the swivel axis. The rear edge can advantageously swivel by at least 5°, in particular by at least 30° and preferably by at least 45° for improved maintenance in addition to adapted soil tillage. The rear edge in particular swivels by at least 90° to provide maintenance access.

Advantageously, for further improved adjustability, at least one front actuator is assigned to the front housing part, via which the front edge of the front housing part can be adjusted in height and/or along the direction of travel.

Preferably, at least one rear actuator is assigned to the rear housing part, via which the rear edge of the rear housing part can be adjusted in height and/or along the direction of travel.

It is understood that the height here is the height above a contact surface or a horizontal ground of the device. Especially in combination with a relatively movable frame, the use of such actuators leads to simple changes in the shape of the housing and thus to an influence on the earth preparation.

The actuators are advantageously arranged on the front or rear edge of the respective housing part due to improved force transmission, but can also be arranged, for example, in a central area of a respective housing part when viewed in the direction of the rotation axis.

The control of the working machine according to the invention for further improved processing of the soil is additionally improved in particular if the shaft is arranged on the frame of the working machine so as to be adjustable in height via a shaft actuating device. In a simple variant, these can be recesses in the frame that are arranged one above the other in height and can be used to attach the respective end bearing of the shaft at different heights.

According to a further embodiment of the invention, at least one vibration generator is provided, which is connected to at least one of the housing parts for generating a vibration thereof. This vibration generator can be integrated into the housing part or arranged on this housing part. The vibration generated by the vibration generator can keep the channel better clear of earth, which enables more defined conditions for earth preparation. Several vibration generators can also be present, particularly across the width of the housing.

If the housing is segmented with several segments arranged next to each other parallel to the direction of travel and forming part of the inner wall, the at least one vibration generator can be assigned to a segment. If there are several vibration generators, several segments can be equipped with one or more vibration generators. The segments or housing parts are in particular provided with a vibration generator on the side of the housing facing away from the channel in relation to a longitudinal position in the direction of travel and/or a cross-width position in relation to the channel, where earth typically adheres more strongly on the side facing the channel during operation.

An excitation signal for the vibration generator is in particular speed-dependent, for example from the driving speed, for which purpose a corresponding control device can record and process a speed signal from the working machine. This control device can be integrated into a machine control unit of the working machine. In addition, the excitation signal can be dependent on the rotational speed of the shaft and/or the ground conditions, for example, the soil moisture, for which purpose a moisture sensor can be provided.

Advantageously, at least one vibration generator is arranged transversely to the direction of travel and, with respect to the direction of travel, between a front and a rear end of one of the respective housing parts. In this respect, it acts on the surface of the housing part formed between the front and rear edges and can cause it to vibrate, in particular largely unaffected by any fastening points of the housing part. Alternatively or additionally, the vibration generator can also act directly on any frame of the respective housing part and thus excite the large parts of the inner wall or the entire inner wall. Preferably, the inner wall of the housing parts is at least partly formed from an elastomeric material for this purpose. Even without a vibration generator, the design of the inner wall of the housing part made of an elastomeric material results in its ability to vibrate, which minimizes the adhesion of earth material.

The vibration generator can alternatively or additionally (then as a further vibration generator) be arranged transversely to the direction of travel at a front or rear end of one of the housing parts with respect to the direction of travel, so that, for example, by moving the front edge up and down, a movement is introduced to the housing part on the one hand via any elastomeric material and on the other hand via an associated swivel about the swivel axis or in the swivel bearing.

Preferably, the vibration generator comprises a vibration means which bears against the housing part or is connected thereto and wherein the vibration means is designed to exert a force on the housing part, in particular in a direction transverse to the planar extension of the housing part. The force is thus applied transversely to the planar extension, so that a vibration with a sufficiently large component is generated in the direction of the shaft's rotation axis, which effectively reduces the build-up of earth on the inner wall of the housing part in the direction of the shaft's rotation axis.

For example, a mechanically simple variant of the vibration means is a vibration means that is designed in particular in the form of a turntable and mounted preferably eccentrically, which can be driven to rotate. This allows the frequency of the vibration to be changed by simply changing the rotational speed. Preferably, the turntable has different edge distances from the rotation axis of its drive as an alternative or in addition to an eccentric bearing.

In addition or alternatively, the vibration means can in particular be longitudinally movable in the direction transversely to the planar extension of the housing part and, for example, be arranged as a rod with its end face on the housing part and cause it to vibrate.

### BRIEF DESCRIPTION OF THE DRAWINGS

Reference is now made more particularly to the drawings, which illustrate the best presently known mode of carrying out the invention and wherein similar reference char-acters indicate the same parts throughout the views.

FIG. 1 shows an isometric view of a subject matter according to an example embodiment of the invention,

FIG. 2 shows a part of the subject matter according to FIG. 1.

FIG. 3 shows a detailed view of a housing part of a subject matter according to an example embodiment of the invention.

FIG. 4 shows a further detailed view of a subject matter according to an example embodiment of the invention.

FIG. 5 shows the subject matter according to FIG. 2 in a partially broken view.

FIG. 6 shows the subject matter according to FIG. 2 in two different operating positions.

FIG. 7 shows a further partial view of the subject matter according to FIG. 1.

FIG. 8 shows a further embodiment of a subject matter according to an example embodiment of the invention in a view according to FIG. 7.

FIG. 9 shows a schematic illustration of another subject matter according to an example embodiment of the invention.

FIG. 10 shows a schematic illustration of another subject matter according to an example embodiment of the invention.

### DETAILED DESCRIPTION OF THE DRAWINGS

Individual technical features of the embodiment examples described below can also be combined with embodiment examples described above and the features of the independent claim and any further claims to form objects according to the invention. Where appropriate, identical reference numbers are assigned to elements that have at least partially the same function.

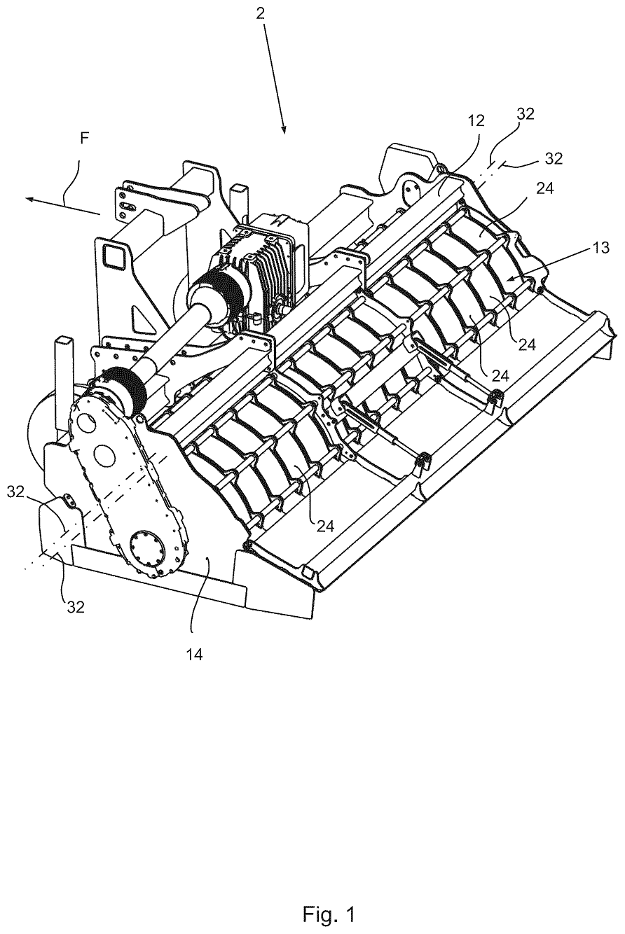

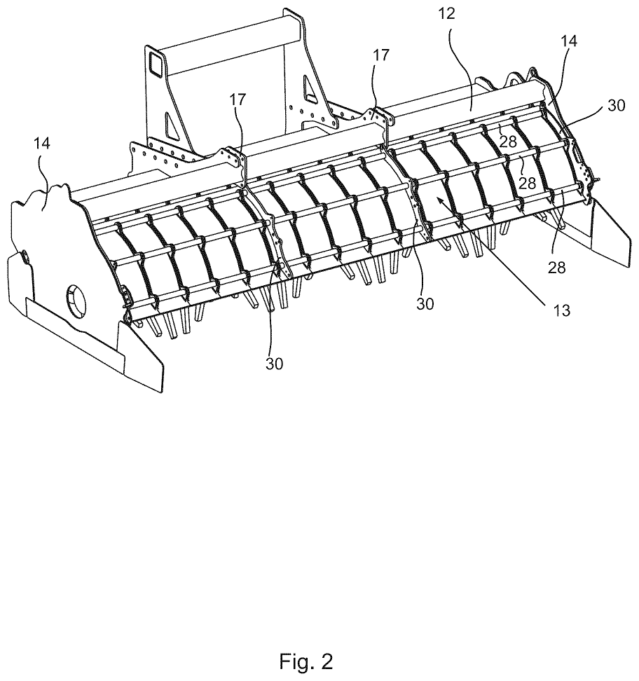

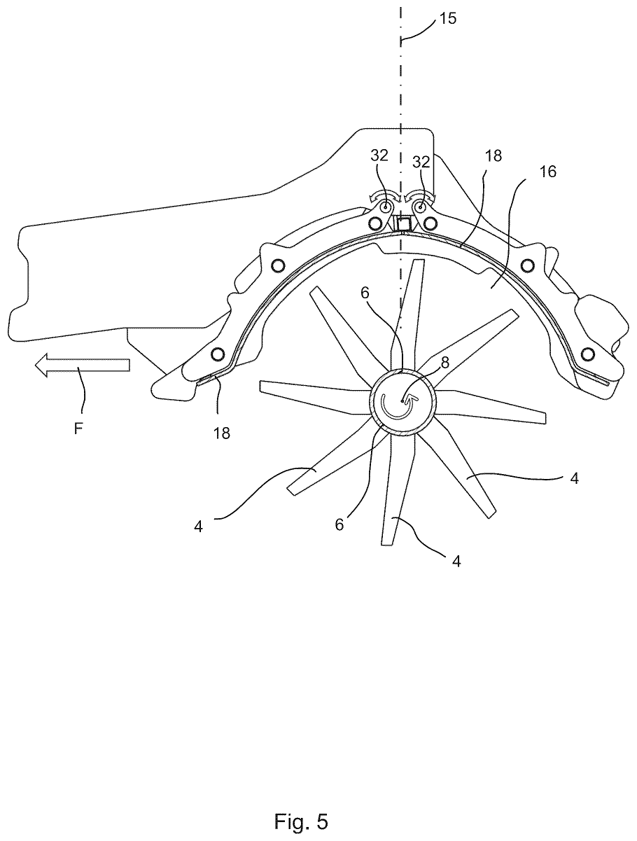

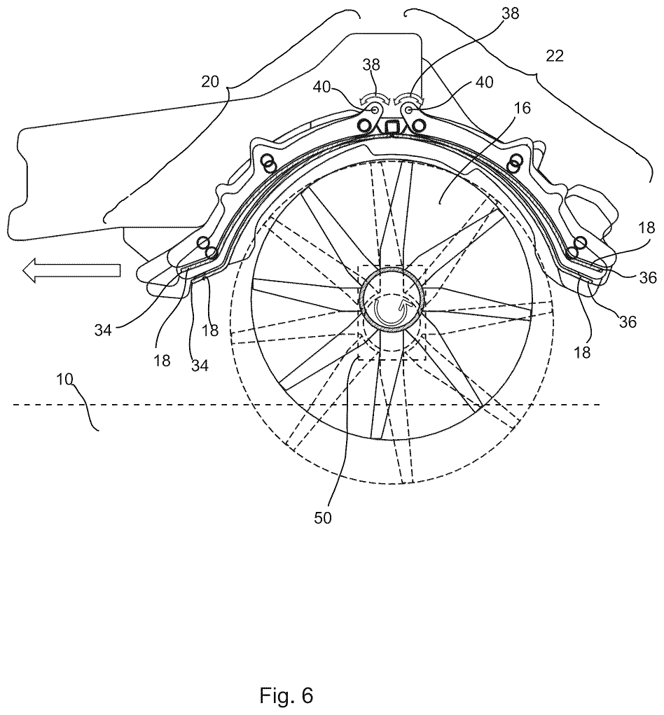

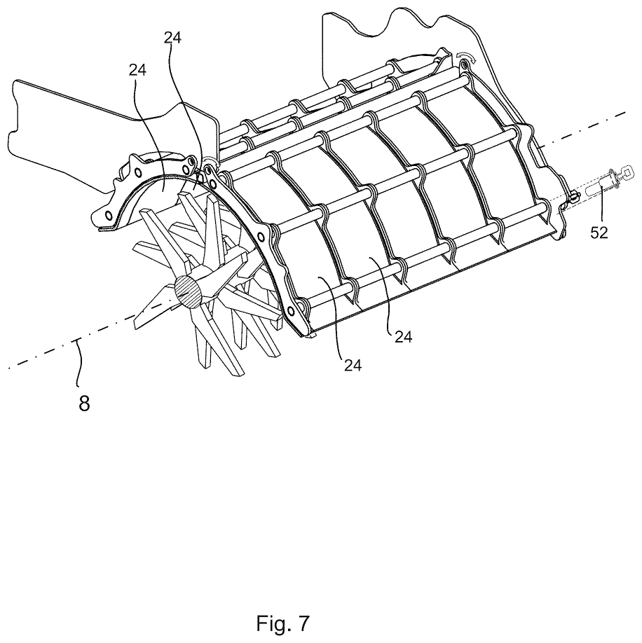

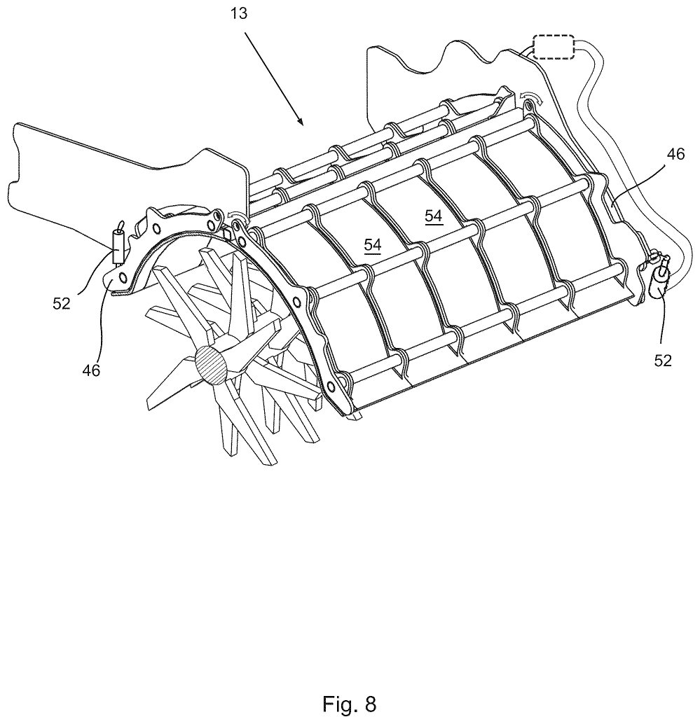

In the present case, an agricultural working machine is a soil tillage machine 2 designed as a soil tiller (FIG. 1). The soil tillage machine 2 has a shaft 6 provided with a plurality of tools 4, whose rotation axis 8 (see FIGS. 5 and 7) extends at an angle to the direction of travel F during operation. In the embodiment example, the rotation axis 8 runs parallel to the ground 10 (FIG. 6). The soil tillage machine 2 further comprises a housing 13 (FIGS. 2 and 8) held on a frame 12, which is arranged over a circumferential angle of almost 180° (FIG. 5) around the shaft 6 and its rotation axis 8.

The housing is arranged at a swivel angle of almost +/−90° above the rotation axis and thus above the shaft in relation to a vertical line 15, which runs through the rotation axis 8 (FIG. 5). A channel 16 is formed between shaft 6 and inner wall parts 18 of the front and rear housing parts 20, 22 of the housing, in and through which the soil or earth is conveyed.

The front housing part 20 and the rear housing part 22 are movably arranged according to the invention and can swivel about swivel axes 32, which are arranged above the shaft 6 (FIG. 6), and can thus be transferred to different operating positions. These are adjustable and can therefore be preset by an operator.

The housing parts 20, 22 are mounted so that they can swivel via side members 30 in side plates 14 and on center plates 17. The housing parts 20, 22 extend in particular completely over the length of the shaft 6 and can assume the two operating positions shown one above the other in FIG. 6 as well as additional intermediate positions not shown. Accordingly, FIG. 6 shows two inner wall parts 18 of the front and rear housing parts. In the two operating positions shown, the two fixed adjustable operating positions of the front housing part 20 differ in that in a swung-open, upper operating position, a front edge 34 is further forward and higher with respect to the ground 10 than the front edge 34 in the swiveled-in, lower position. The same applies to the rear edge 36 of the rear housing part 22. The mobility of the front and rear housing parts 20, 22 is indicated by double arrows 38 in the area of swivel bearings 40.

In general, the housing of the soil tillage machine 2 is formed by a front and rear housing part 20 and 22, wherein the inner wall of the housing is formed by the two (front and rear) inner wall parts 18.

For their part, the inner wall parts 18 and thus also the inner wall of the housing are formed in each case by a plurality of identical segments 24 arranged next to one another when viewed in the direction of travel. The segments 24 are sheet-like, in particular strip-shaped, and are longer when viewed parallel to the direction of travel than transversely. This takes account of the fact that the relevant movement of the earth and thus the wear also takes place in the direction of travel and in the circumferential direction around the shaft 6. Areas that are particularly susceptible to wear, depending on the tool configuration, can thus be easily replaced without having to replace the entire housing wall or inner wall of the housing 13. Both the front and rear housing parts 20, 22 are made up of segments 24.

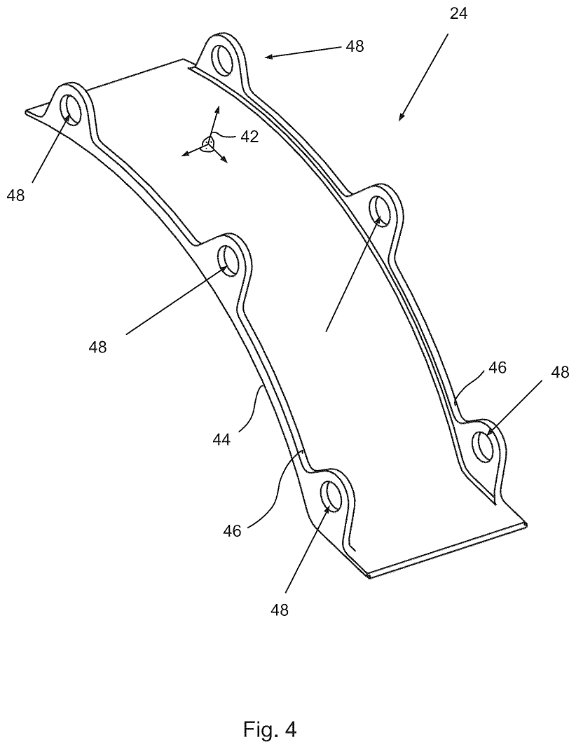

The segments 24 are formed entirely by an elastomeric material with a Shore hardness A of between 75 and 95 and can oscillate or vibrate accordingly, in particular in a direction parallel to the vertical 42 (FIG. 4).

The segments 24 have longitudinal webs 46 running along their longitudinal edges 44, which stiffen the segments 24. At the same time, the longitudinal webs 46 form receptacles 48 through thickened, widened areas, via which the segments 24 are attached to the cross members 28. These in turn are mounted in the side members 30, wherein one or more cross members can be mounted so as to be relatively movable with respect to the side members 30 via elongated holes not shown. The cross and side members 28, 30 each form a housing part frame, which can swivel relative to the frame 12.

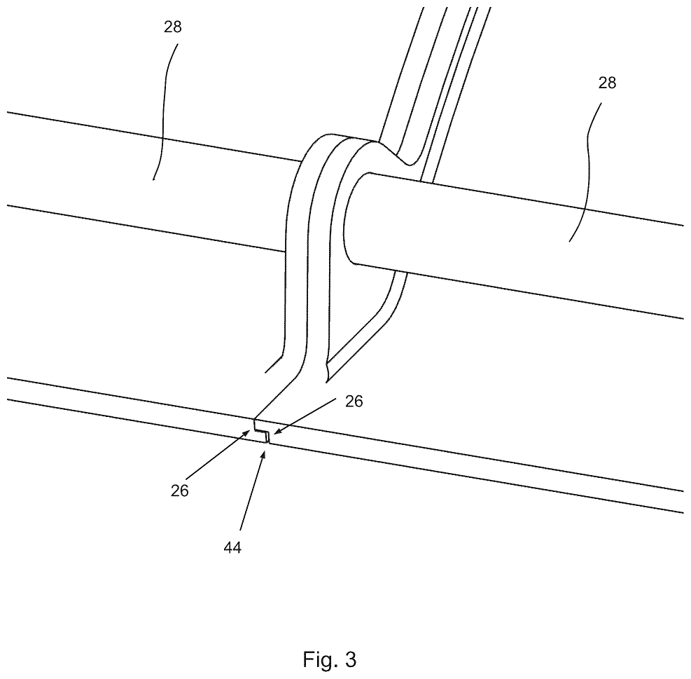

For better and more sealing contact of the segments, these have recesses or shoulders 26 along the longitudinal edges 44, which have complementary shapes on the sides facing each other (FIG. 3) and via which a seal is created in the contact with each other, due to which the earth is held better in the channel 16. Segments 24 arranged next to each other are therefore partially overlapping.

The receptacles 48 provide fastening means that can be used for fastening to the housing frame or also for fastening to each other. Corresponding to the different operating states of the rear and front housing parts 20, 22, the segments 24 also have correspondingly different operating states with different distances of the inner wall from the rotation axis 8.

In addition, the soil tillage machine 2 is provided with a shaft actuating device 50, shown only in dashed lines and arranged at the end of the shaft 6, by means of which the shaft can be moved into the position shown in dashed lines in FIG. 6 and fixed there. The shaft actuating device 50 is arranged on the frame 12 of the soil tillage machine 2 so that it can be adjusted in height.

Both the front and the rear housing parts 20, 22 are adjustable via a front and a rear actuator 52, namely adjustable about the respective swivel axis 32, which in FIG. 5, for example, runs perpendicular to the plane of the figure in each case. For example, the actuator 52 is a hydraulic cylinder that is fixed on the frame side and attached to a side member 46 (FIG. 8) or a simple mechanical fixing of the housing parts 20, 22 to the frame 12 via a screw means whose length can be varied (FIG. 7).

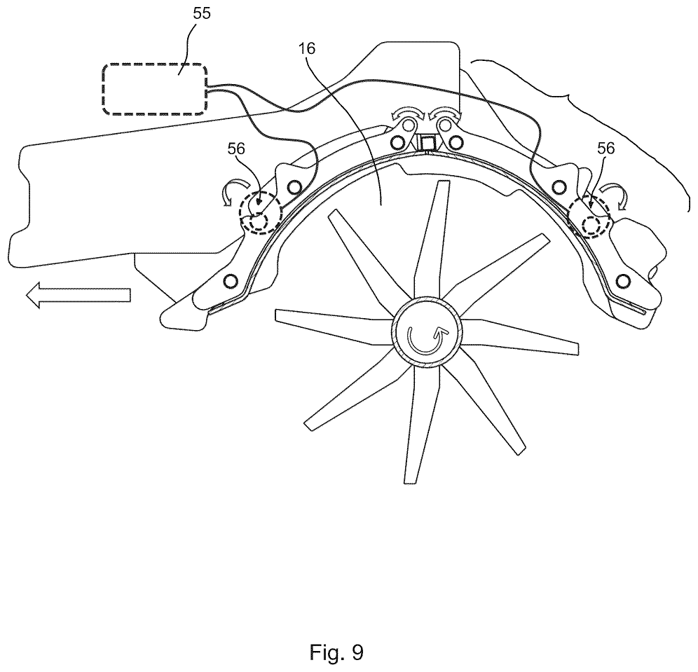

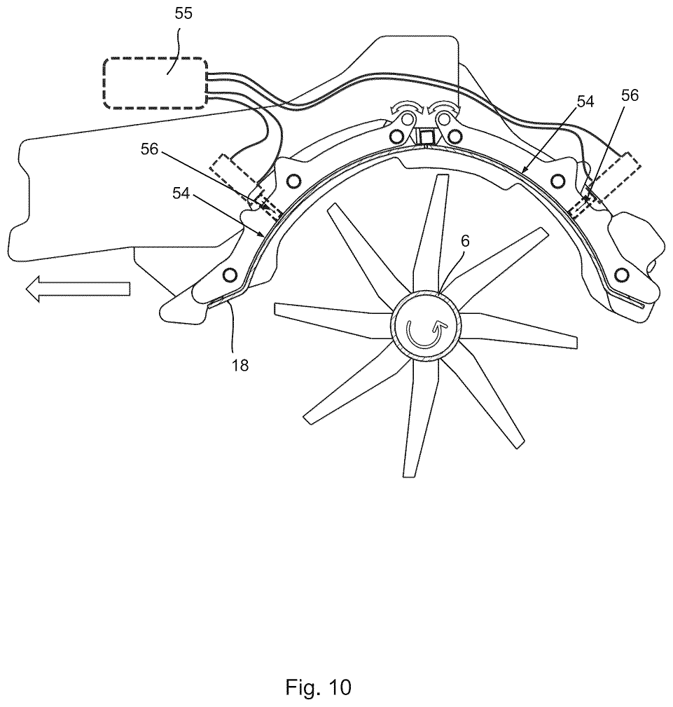

Vibration generators arranged on the frame side transmit vibrations to the outer surfaces 54 via their vibration means 56. As a result, the rotational speeds of vibration means 56 in the form of eccentrically arranged rotating disks or the frequencies of vibration means 56 in the form of longitudinally movable stamps perpendicular to the surface 54 are predetermined, in particular depending on the speed, via a corresponding control device 55, which can be part of the machine control of the working machine (FIGS. 9 and 10).

1. An agricultural working machine comprising:
a shaft provided with at least one tool, the rotation axis of which extends in operation at an angle to a direction of travel (F) and at least substantially parallel to the ground;
a housing arranged on a frame of the working machine, which housing is arranged at least in sections above the shaft and has an inner wall delimiting a channel between the shaft and the housing;
wherein the housing has a front movable housing part and a rear movable housing part with respect to the direction of travel, with respective inner wall parts which each extend along the shaft and which each have at least two adjustable, different operating positions in which the respective inner wall parts of the housing parts are positioned differently to the shaft.

2. The working machine according to claim 1, wherein the front movable housing part and rear movable housing part swivel relative to the frame about at least one swivel axis.

3. The working machine according to claim 2, wherein respective swivel bearings are formed at the mutually facing ends of the front movable housing part and rear movable housing part.

4. The working machine according to claim 1, wherein at least one cross member and/or at least one side member is provided to stiffen at least one of the front movable housing part or the second movable housing part.

5. The working machine according to claim 1, wherein the inner wall parts are at least formed from an elastomeric material.

6. The working machine according to claim 4, wherein side and cross members of a respective front movable housing part or rear movable housing part are attached to one another to form a housing part frame.

7. The working machine according to claim 1, wherein at least one of the inner wall parts has different radii of curvature in at least two operating states.

8. The working machine according to claim 1, wherein at least one front actuator is assigned to the front movable housing part, via which a front edge of the front movable housing part is adjustable in height and/or along the direction of travel (F).

9. The working machine according to claim 1, wherein at least one rear actuator is assigned to the rear movable housing part, via which the rear edge of the rear movable housing part is adjustable in height and/or along the direction of travel (F).

10. The working machine according to claim 1, wherein the shaft is arranged on the frame of the working machine so as to be adjustable in height via a shaft actuating device.

11. The working machine according to claim 1, further including at least one vibration generator connected to at least one of the front movable housing part or the rear movable housing part for exciting a vibration thereof.

12. The working machine according to claim 11, wherein the vibration generator is arranged transversely to the direction of travel (F) and, with respect to the direction of travel, between a front and a rear end of one of the front movable housing part and the rear movable housing part.

13. The working machine according to claim 11, wherein the vibration generator is arranged at a front or rear end of one of the front movable housing part and the rear movable housing part with respect to the direction of travel (F) when viewed transversely to the direction of travel.

14. The working machine according to claim 11, wherein the vibration generator comprises a vibration means which bears against the housing part or is connected thereto and wherein the vibration means is designed to exert a force on the housing part.

15. The working machine according to claim 14, wherein the vibration means, which is designed, can be driven in rotation and/or is longitudinally movable in the direction transverse to the planar extension of the housing part (22).

16. The working machine according to claim 2, wherein the front movable housing part and rear movable housing part swivel relative to the frame about a swivel axis that runs at an angle to the direction of travel (F).

17. The working machine according to claim 16, wherein the front movable housing part and rear movable housing part swivel relative to the frame about a swivel axis that runs parallel to the rotation axis of the shaft.

18. The working machine according to claim 3, wherein respective swivel bearings are formed at the mutually facing ends of the front movable housing part and rear movable housing parts above the inner wall parts delimiting the channel.

19. The working machine according to claim 6 wherein at least one of the side members is arranged to move relative to at least one of the cross members and/or at least one inner wall part is arranged to move relative to the housing part frame.

20. The working machine according to claim 14, wherein vibration means is designed to exert the force on the housing part in a direction transverse to the planar extension of the housing part.
